(19) United States
(12) Patent Application Publication
(10) Pub. No.: US 2008/0260312 A1
(43) Pub. Date: Oct. 23, 2008

(54) Motor having improved mechanism

(75) Inventors: Hirotake Nishino, Shizuoka-ken (JP); Junichi Kamijo, Shizuoka-ken (JP)

Correspondence Address: LOUIS WOO;LAW OFFICE OF LOUIS WOO, 717 NORTH FAYETTE STREET, ALEXANDRIA, VA, 22314, US

(73) Assignee: Victor Company of Japan, Ltd., Yokohama (JP)

(21) Appl. No.: 11/907,975

(22) Filed: Oct. 19, 2007

(30) Foreign Application Priority Data
Nov. 24, 2006 (JP) 2006-317218

(51) Int. Cl. F16C 17/08; G02B 26/10

(52) U.S. Cl. 384/446

(57) ABSTRACT

A motor having improved mechanism is composed of a body of revolution having a mounting hole in the center of the body; a rotor hub having a boss section to be inserted into the mounting hole of the body of revolution and a flange section supporting the body of revolution; and an elastic plate installed coaxially to the rotor hub and pressing the body of revolution on the flange section of the rotor hub, wherein the elastic plate is provided with a plain section having a hole in the center and a plurality of arm sections extending radially from an outer circumference of the plain section, and wherein each of the arm sections is provided with a first slanting section that is inclined with respect to the plain section and a second slanting section having an angle of gradient different from that of the first slanting section, and further wherein the first slanting section contacts with an outer circumferential edge of the boss section that confronts with an inner wall surface of the mounting hole of the body of revolution and the second slanting section contacts with a top end edge of the inner wall surface of the mounting hole.

### BACKGROUND OF THE INVENTION

1. Field of the Invention

This invention relates to a motor having improved mechanism for rotating a polygon mirror and a recording medium in disciform such as a hard disc, particularly, relates to a motor having improved mechanism suitable for retaining a body of revolution such as a polygon mirror so as to be balanced well.

2. Description of the Related Art

Generally, it is required for motors to be used in precision instruments as a driving source that the motors should exhibit excellent rotational performances high in accuracy without any unbalanced revolution. In the case of a polygon mirror motor to be used in a laser beam printer (LBP), for instance, the polygon mirror motor is required to retain a polygon mirror as a body of revolution so as to be concentric with a rotor shaft and to rotate the polygon mirror in higher rotational speed without unbalancing the revolution.

One example of such a polygon mirror motor (polygon scanner motor) is disclosed in the Japanese publication of unexamined patent applications No. 2006-187970.

FIG. 9 is a cross sectional view of a polygon mirror motor (polygon scanner motor) according to the prior art (Japanese publication of unexamined patent applications No. 2006-187970).

As shown in FIG. 9, the polygon scanner motor is provided with a mirror holding spring that is composed of two dish-shaped springs S1 and S2, which are piled up one on the other. A vicinity of an inner diameter section of the one dish-shaped spring S1 is in contact with an edge (open end) section of a hitting hole “h” in a polygon mirror Pm1. On the other hand, a vicinity of an inner diameter section of the other dish-shaped spring S2 is fixed to a hook section “e”, which is formed on a rotor shaft Rs. By the specific configuration of the dish-shaped springs S1 and S2, the polygon mirror Pm1 is pressed on and fixed to a receiving surface of a flange section “f” of a boss, which is fixed to the rotor shaft Rs.

Another example of such a polygon mirror motor is disclosed in the Japanese publication of unexamined patent applications No. 8-262361/1996.

FIG. 10 is a partially enlarged cross sectional view of another polygon mirror motor according to the other prior art (Japanese publication of unexamined patent applications No. 8-262361/1996).

As shown in FIG. 10, the polygon mirror motor is provided with a locking member “k” in a flat ring shape, which is formed with a plurality of projections “p”, in a conical shape. Each of the plurality of projections “p” is engaged with an annular groove “g” of a polygon mirror Pm2, which is placed on a mirror seating surface, and resulting in fixing the polygon mirror Pm2 positionally.

However, in the case of the polygon mirror motor shown in FIG. 9 according to the Japanese publication of unexamined patent applications No. 2006-187970, the mirror holding spring is constituted by two dish-shaped springs S1 and S2 being piled up one on the other. In this regard, a total length in the vertical direction of the mirror holding spring holding the polygon mirror Pm1 varies by a production batch due to positional variation of the dish-shaped springs S1 and S2 when piling one onto the other. Particularly, pressure force in the radial direction acting on the polygon mirror Pm1 changes, and resulting in a problem such that coaxial accuracy of the polygon mirror Pm1 is deteriorated.

In other words, according to the Japanese publication of unexamined patent applications No. 2006-187970, the mirror holding spring is hard to be processed or manufactured in higher accuracy. The defective accuracy makes pressure force in the radial direction of the polygon mirror vary.

Accordingly, the motor is not suitable for a polygon mirror motor to rotate a polygon mirror in a higher rotational speed without unbalancing the revolution of the polygon mirror.

On the other hand, in the case of the Japanese publication of unexamined patent applications No. 8-262361/1996, the annular groove “g” shown in FIG. 10 must be formed on the polygon mirror Pm.

Further, the locking member “k” is fixed to a sleeve “s”, which forms the mirror seating surface, by a plurality of screws “n”. Consequently, fastening torque of the screw “n” makes pressure force, which acts on the polygon mirror Pm2, change by location. Particularly, since the projection “p” formed on the locking member “k” is formed in a conical shape, elasticity of the projection itself is extremely small. In this regard, such a phenomenon that makes the locking member “k” irregularly rise occurs by shock or vibration.

Accordingly, the phenomenon generates further problem such that revolution of the polygon mirror Pm2 is made unstable.

### SUMMARY OF THE INVENTION

Accordingly, in consideration of the above-mentioned problems of the prior arts, an object of the present invention is to provide a motor having improved mechanism, which enables to retain a body of revolution such as a polygon mirror stably and to rotate the body of revolution in higher rotational speed without unbalancing the revolution.

In order to achieve the above object, the present invention provides, according to an aspect thereof, a motor having improved mechanism comprising: a body of revolution having a mounting hole in the center of the body; a rotor hub having a boss section to be inserted into the mounting hole of the body of revolution and a flange section supporting the body of revolution; and an elastic plate installed coaxially to the rotor hub and pressing the body of revolution on the flange section of the rotor hub, wherein the elastic plate is provided with a plain section having a hole in the center and a plurality of arm sections extending radially from an outer circumference of the plain section, and wherein each of the arm sections is provided with a first slanting section that is inclined with respect to the plain section and a second slanting section having an angle of gradient different from that of the first slanting section, and further wherein the first slanting section contacts with an outer circumferential edge of the boss section that confronts with an inner wall surface of the mounting hole of the body of revolution and the second slanting section contacts with a top end edge of the inner wall surface of the mounting hole.

Other object and further features of the present invention will be apparent from the following detailed description when read in conjunction with the accompanying drawings.

### BRIEF DESCRIPTION OF THE DRAWINGS

FIG. 1 is a cross sectional view of a motor having improved mechanism according to a first embodiment of the present invention.

FIG. 2 is a plan view of the motor having improved mechanism shown in FIG. 1 exhibiting a holding state of a polygon mirror according to the first embodiment of the present invention.

FIG. 3 is an enlarged plan view of a first elastic plate holding the polygon mirror in place according to the first embodiment of the present invention.

FIG. 4 is a cross sectional view of the first elastic plate taken substantially along line X-X of FIG. 3.

FIG. 5 is an explanatory cross sectional view of the motor having improved mechanism as in FIG. 1 showing a rotor section in a state when the first elastic plate is mounted on a rotor hub.

FIG. 6 is a partially enlarged cross sectional view of the motor having improved mechanism shown in FIG. 5 exhibiting a state when the polygon mirror is retained by the first elastic plate.

FIG. 7(a) is a plan view of a second elastic plate according to a second embodiment of the present invention.

FIG. 7(b) is a cross sectional view of the second elastic plate taken substantially along line Y-Y of FIG. 7(a).

FIG. 8(a) is a perspective view of a third elastic plate according to a third embodiment of the present invention.

FIG. 8(b) is a cross sectional view of the third elastic plate shown in FIG. 8(a).

FIG. 9 is a cross sectional view of a polygon mirror motor according to the prior art.

FIG. 10 is a partially enlarged cross sectional view of another polygon mirror motor according to the other prior art.

### DETAILED DESCRIPTION OF THE INVENTION

### First Embodiment

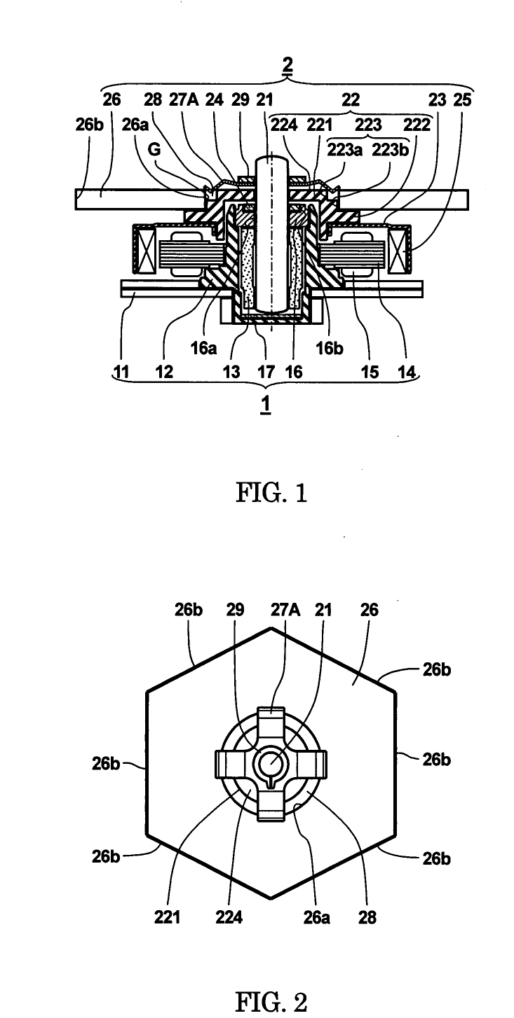

In reference to FIGS. 1-6, a motor having improved mechanism according to a first embodiment of the present invention is detailed next. In this embodiment, description is given to a polygon mirror motor as an example of a motor having improved mechanism. However, the motor having improved mechanism enables to be applied for an HDD (hard disc drive) motor, which rotates a hard disc as a body of revolution, and a disc driving motor, which rotates discs other than a hard disc.

FIG. 1 is a cross sectional view of a motor having improved mechanism according to a first embodiment of the present invention.

FIG. 2 is a plan view of the motor having improved mechanism shown in FIG. 1 exhibiting a holding state of a polygon mirror according to the first embodiment of the present invention.

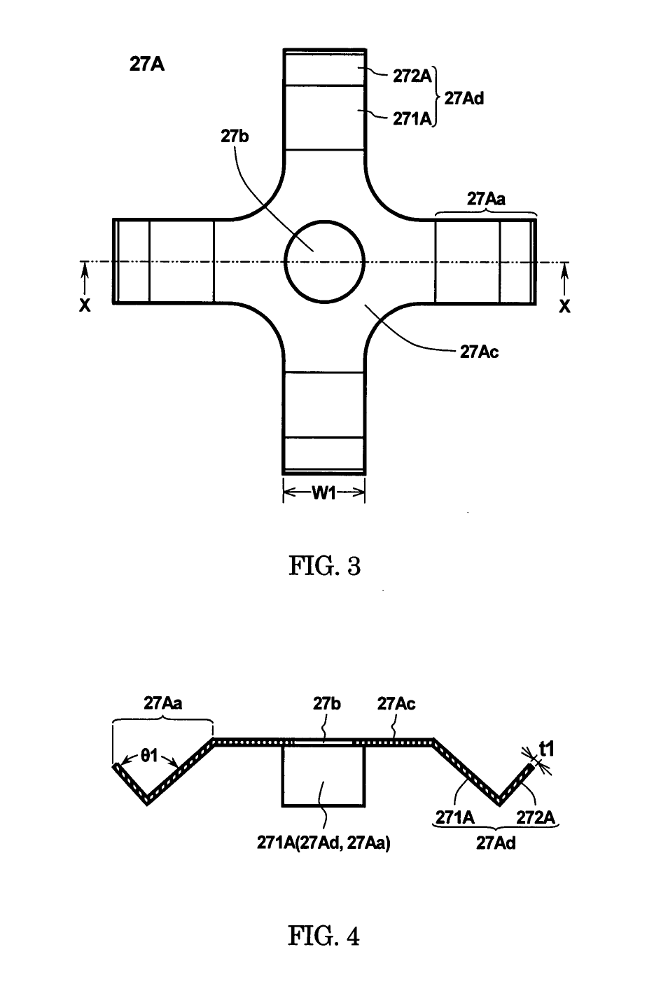

FIG. 3 is an enlarged plan view of a first elastic plate holding the polygon mirror in place according to the first embodiment of the present invention.

FIG. 4 is a cross sectional view of the first elastic plate taken substantially along line X-X of FIG. 3.

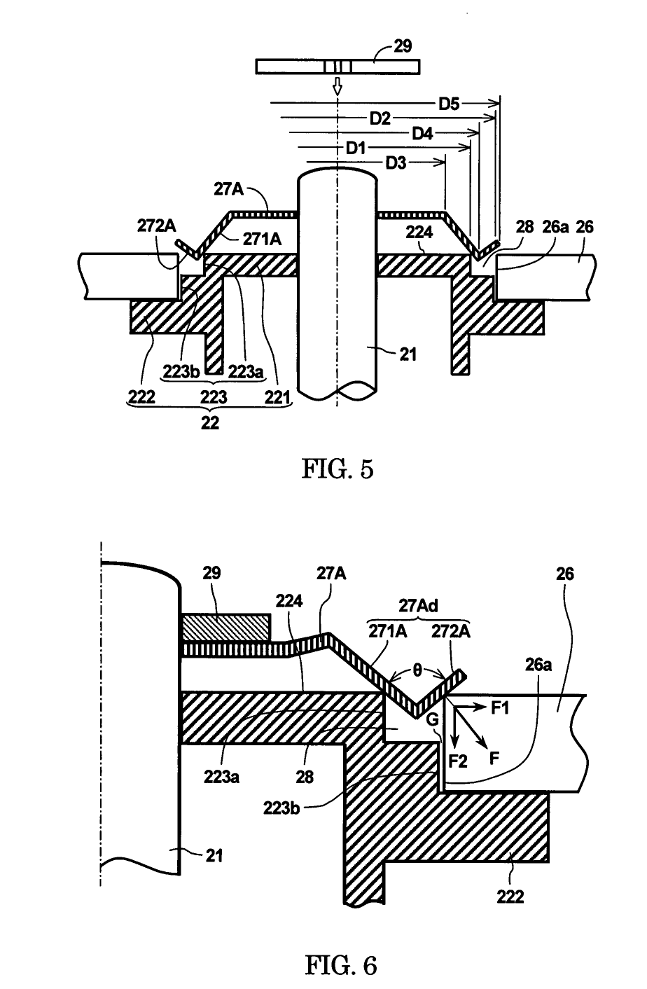

FIG. 5 is an explanatory cross sectional view of the motor having improved mechanism as in FIG. 1 showing a rotor section in a state when the first elastic plate is mounted on a rotor hub.

FIG. 6 is a partially enlarged cross sectional view of the motor having improved mechanism shown in FIG. 5 exhibiting a state when the polygon mirror is retained by the first elastic plate.

FIG. 1 is a cross sectional view of a motor having improved mechanism showing a constitutional example of a polygon mirror motor, that is, a brushless motor for a scanning device according to the first embodiment of the present invention. The motor constitutes a major part of a scanning device used in a laser beam printer (LBP) and its configuration is a so-called outer rotor type motor in which a rotor is disposed outside a stator so as to surround the stator.

In FIG. 1, a motor having improved mechanism (hereinafter generically referred to as motor) is essentially composed of a stator 1 and a rotor 2. The stator 1 is further composed of a motor base 11 in a plate that is fixed inside a device such as an LBP, a bearing casing 12 in a cylindrical shape that is fixed to the motor base 11 with passing through the motor base 11, and a bearing 13 in a cylindrical shape that is inserted into the bearing casing 12.

Further, a stator core 14, which is formed by a laminated material such as silicon steel plates, is engaged with and fixed to an outer circumferential section of the bearing casing 12, and a stator coil 15, which is supplied with driving current or armature current, is wound around the stator core 14.

Furthermore, the bearing 13 is a fluid bearing or a radial bearing that is constituted by an oil impregnated metal, wherein a rotor shaft 21 is passed through a center hole or through hole of the bearing 13. Lubricating oil that generates dynamic pressure is filled in a gap between an inner circumferential surface of the through hole of the bearing 13 and an outer circumferential surface of the rotor shaft 21.

More, a bearing cap 16 having an annular recessed section 16b is engaged with an upper end opening section of the bearing casing 12. The bearing cap 16 achieves a role in preventing the bearing 13 from being removed from the bearing casing 12 and another role in preventing the lubricating oil impregnated in the bearing 13 from leaking out. In the center of the bearing cap 16, a tapered hole 16a through which the rotor shaft 21 passes, is formed.

Moreover, the bearing 13 accepts radial load that acts on the rotor shaft 21 radially. On the other hand, thrust load is accepted by a receiving seat 17 that is disposed inside the bearing casing 12 on the bottom.

In addition thereto, it should be understood that the bearing 13 enables to be replaced by another bearing such as a slide bearing and a rolling bearing.

On the other hand, as shown in FIG. 1, the rotor 2 is composed of the rotor shaft 21 that is supported by the bearing 13 so as to be rotatable freely, a rotor hub 22 that is engaged with and fixed to a top end portion of the rotor shaft 21, and a rotor yoke 23 that is integrally fixed to the rotor hub 22.

Further, an oil deflector 24 in an annular shape, which is disposed inside the annular recessed section 16b that is formed on the top end surface of the bearing cap 16, is fixed to an outer circumferential section of the rotor shaft 21.

Furthermore, on an inner circumferential surface of the rotor yoke 23, a field magnet 25, which generates field magnetic flux that is necessary for the rotor 2 to generate turning effort, at a position facing toward the stator core 14.

More, the rotor 2 is further composed of a polygon mirror (body of revolution) 26 having a mounting hole 26a in the middle, a first elastic plate (leaf spring) 27A that retains the polygon mirror 26 firmly in place, a recessed section 28 in an annular shape that is formed between an outer circumferential surface of the rotor hub 22 and an inner wall surface of the mounting hole 26a of the polygon mirror 26, and a retainer plate 29 in a ring shape.

Moreover, the rotor hub 22 is provided with a boss section 221, which is inserted into the mounting hole 26a of the polygon mirror 26, and a flange section 222 on which the polygon mirror 26 is installed and retained thereon.

In addition thereto, the boss section 221 is provided with a cylindrical section 223, which forms the flange section 222 in an outer circumferential area of the cylindrical section 223, and a plane section 224, which is a top surface of the cylindrical section 223. In this connection, the cylindrical section 223 is formed into a two step construction that is provided with a small diameter section 223a and a large diameter section 223b.

The polygon mirror 26 is loaded onto the rotor hub 22, and finally pressed down to the flange section 222 of the rotor hub 22 by the first elastic plate 27A, which is engaged with the rotor shaft 21.

When the polygon mirror 26 is placed on the flange section 222 of the rotor hub 22, the recessed section 28 in an annular shape is formed between the inner wall surface of the mounting hole 26a of the polygon mirror 26 and an outer circumferential surface of the small diameter section 223a of the boss section 221 of the rotor hub 22. A part of the first elastic plate 27A is inserted into the recessed section 28.

Further, between the inner wall surface of the mounting hole 26a of the polygon mirror 26 and an outer circumferential surface of the large diameter section 223b of the cylindrical section 223 of the rotor hub 22, there is provided a minute gap “G” so as to be able to load or remove the polygon mirror 26 easily without any mechanical resistance or obstacle.

In FIG. 1, the retainer plate 29 presses the first elastic plate 27A downward to the polygon mirror 26 side. The retainer plate 29 is fastened on the rotor shaft 21 by a not shown screw. In this connection, a snap ring that is expansible in a radial direction can be used for the retainer plate 29. In this case, an annular groove shall be formed on an outer circumferential surface of the rotor shaft 21 so as to insert the snap ring thereinto.

By the above-mentioned configuration of the motor having improved mechanism according to the present invention, the polygon mirror 26 is rotated in a higher speed, and deflects and reflects a not shown laser beam that is irradiated from a not shown light source such as a semiconductor laser device. The reflected laser beam is focused onto a not shown photosensitive element on a not shown rotary drum so as to form an electrostatic latent image on the photosensitive element.

More specifically, as shown in FIG. 2, the polygon mirror 26 is formed in a hexagonal shape. Each of six end surfaces 26b of the polygon mirror 26 is formed as a reflective surface for a laser beam so as to deflect and reflect the laser beam to the not shown rotary drum.

In reference to FIGS. 3-6, the first elastic plate 27A is detailed next. FIG. 3 is an enlarged top view of the first elastic plate 27A, and FIG. 4 is a cross sectional view of the first elastic plate 27A taken substantially along line X-X of FIG. 3. As shown in FIG. 3, the first elastic plate 27A is a metal leaf spring in a cross shape having four arm sections 27Aa that extend radially from the center of the plate at even intervals of 90 degrees. A center hole 27b of which diameter is larger than the diameter of the rotor shaft 21 is provided in the center of the first elastic plate 27A. In the first embodiment of the present invention, a thickness “t1” of the first elastic plate 27A and a width “W1” of each arm section 27Aa in FIG. 4 is 0.3 mm and 3 mm respectively.

Further, each arm section 27Aa is turned down at a slant with respect to a flat section 27Ac that is provided with the center hole 27b.

Furthermore, as shown in FIG. 4, each tip section of the arm sections 27Aa is folded in reverse to the slanting direction of the arm section 27Aa and formed in a pressurizing section 27Ad in a V-letter shape. The pressurizing section 27Ad is constituted by a first slanting section 271A of which inclination is the same as that of the arm section 27Aa, and a second slanting section 272A, which forms a replicated section in the tip of the arm section 27Aa. An interior angle θ1 of the pressurizing section 27Ad is designated to be 90 degrees in the first embodiment of the present invention.

More, the first elastic plate 27A enables to be formed in higher accuracy by a press work so as to arrange a plurality of the first slanting sections 271A and a plurality of the second slanting sections 272A to be on a same circumference respectively.

FIG. 5 shows a state of the first elastic plate 27A when the first elastic plate 27A is engaged with the rotor shaft 21. In FIG. 5, an inner diameter of the recessed section 28, that is, a diameter of the small diameter section 223a is defined as D1, and an outer diameter of the recessed section 28, that is, an inner diameter of the mounting hole 26a of the polygon mirror 26 is defined as D2. In case the first elastic plate 27A is not applied with any load thereon, each arm section 27Aa is folded in 45 degrees downward at a position having a diameter D3 that is smaller than the diameter D1, and resulting in forming the first slanting section 271A. On the other hand, the tip portion of each arm section 27Aa is replicated in 90 degrees upward at a position having a diameter D4 that is larger than D1 and smaller than “(D1+D2)/2”, and resulting in forming the second slanting section 272A. The second slanting section 272A extends to a position having a diameter D5 that is larger than the diameter D2.

In the first embodiment of the present invention, each diameter of D1, D2, D3, D4 and D5 is designed to be 20.4 mm, 25.3 mm, 14.9 mm, 22.8 mm and 26.8 mm respectively.

By the first elastic plate 27A designed as mentioned above, as shown in FIG. 5, the first slanting section 271A of the first elastic plate 27A firstly contacts with a top end edge of the inner circumferential side of the recessed section 28 when the first elastic plate 27A is engaged with the rotor shaft 21. In other words, the first slanting section 271A firstly contacts with the boss section 221 of the rotor hub 22 at an outer circumferential edge of an intersection of the cylindrical section 223 and the plane section 224 of the rotor hub 22 (hereinafter referred to as “outer circumferential edge of the boss section 221”) when the first elastic plate 27A is engaged with the rotor shaft 21. Then the first elastic plate 27A is centered with respect to the rotor hub 22.

More specifically, the outer circumferential edge of the boss section 221 is in a circular shape that is concentric with the rotor shaft 21.

Further, the first elastic plate 27A is provided with the center hole 27b of which diameter is larger than that of the rotor shaft 21, so that the first elastic plate 27A enables to move in the radial direction with respect to the rotor shaft 21.

Furthermore, a plurality of the first slanting sections 271A of the first elastic plate 27A contacts with the outer circumferential edge of the boss section 221 at respective positions. In the case of the first embodiment, the number of first slanting sections 271A is four.

Accordingly, the first elastic plate 27A is centered at a position that is concentric with the rotor hub 22 as well as the rotor shaft 21.

When the first elastic plate 27A is pressed downward to the rotor hub 22 while the first elastic plate 27A is centered, the first elastic plate 27A is made to be elastic deformation such that the first slanting section 271A is made expand outward to an outer circumferential side of the recessed section 28. By the elastic deformation, the second slanting section 272A of the first elastic plate 27A secondarily contacts with a top end edge of the inner wall surface of the mounting hole 26a of the polygon mirror 26 at the outer circumferential side of the recessed section 28. In other words, the second slanting section 272A secondarily contacts with a top end circumferential edge of an intersection of the mounting hole 26a and a top surface of the polygon mirror 26 (hereinafter referred to as “top end circumferential edge of the mounting hole 26a”). In this regard, by engaging the retainer plate 29 with the rotor shaft 21 while the second slanting section 272A contacts with the top end circumferential edge of the mounting hole 26a, the first elastic plate 27A is securely fastened in position.

Hereupon, secondarily contacting the second slanting section 272A with the top end circumferential edge of the mounting hole 26a is denoted that the first slanting section 271A contacts with the outer circumferential edge of the boss section 221 of the rotor hub 22 in advance of contacting the second slanting section 272A with the top end circumferential edge of the mounting hole 26a of the polygon mirror 26.

FIG. 6 shows the first elastic plate 27A of which the first slanting section 271A firstly contacts with the outer circumferential edge of the boss section 221 of the rotor hub 22, and the second slanting section 272A secondly contacts with the top end circumferential edge of the mounting hole 26a of the polygon mirror 26. In this bout, as shown in FIG. 6, the polygon mirror 26 is applied with component force F1 in the radial direction of pressure force “F” that is applied to the polygon mirror 26 by the second slanting section 272A.

Accordingly, the polygon mirror 26 is centered with maintaining the minute gap “G” between the inner wall surface of the mounting hole 26a of the polygon mirror 26 and the outer circumferential surface of the large diameter section 223b of the rotor hub 22 as a range of micromotion in the radial direction.

In other words, the plurality of second slanting sections 272A, which is disposed on the same circumference respectively, secondly contacts with the top end circumferential edge of the mounting hole 26a of the polygon mirror 26 while the first elastic plate 27A is disposed with being concentric with the rotor shaft 21 by the action of the first slanting section 271A of the first elastic plate 27A. Consequently, the polygon mirror 26 is also fixed with being concentric with the rotor hub 22 as well as the rotor shaft 21.

Further, the polygon mirror 26 is firmly pressed on the flange section 222 of the rotor hub 22 by component force “F2” in the thrust direction of the pressure force “F” caused by the second slanting section 272A, and resulting in preventing the polygon mirror 26 from moving in the thrust direction.

Accordingly, the polygon mirror 26 rotates excellent in balance along with the rotor shaft 21 without unbalancing the revolution even in a higher rotational speed, and maintains the concentric state with the rotor shaft 21.

In the first embodiment of the present invention, the motor having improved mechanism is described in one specific mode such that the first slanting section 271A contacts with the rotor hub 22 in advance of contacting the second slanting section 272A with the polygon mirror 26 as mentioned above. The reason why the specific mode is adopted in the first embodiment is described next.

In case the second slanting section 272A contacts with the polygon mirror 26 first, the polygon mirror 26 is pressed and fasten in the position where the second slanting section 272A contacts, and resulting in hardly contacting the first slanting section 271A with the boss section 221 even though the first elastic plate 27A is pressed downward furthermore. If the first slanting section 271A contacted with the boss section 221, action caused by the first slanting section 271A for compensating concentric degree of the polygon mirror 26 with respect to the rotor shaft 21 is hardly exhibited because the polygon mirror 26 has been already pressed on the flange section 222 firmly.

According to the first embodiment of the present invention, both the plane section 224 of the rotor hub 22 and the top surface of the polygon mirror 26 are designed to be the same level plane. In case the plane section 224 of the rotor hub 22 is higher than the top surface of the polygon mirror 26 vertically, the above-mentioned diameter D4 should be designed to be increased by twice the vertical interval between them. In case the top surface of the polygon mirror 26 is higher than the plane section 224 vertically, the above-mentioned diameter D4 should be designed to be decreased by twice the vertical interval between them. In this regard, the first slanting section 271A enables to contact with the outer circumferential edge of the boss section 221 of the rotor hub 22 in advance of contacting the second slanting section 272A with the top end circumferential edge of the mounting hole 26a of the polygon mirror 26.

Accordingly, the polygon mirror 26 enables to be centered accurately in place.

Further, in case the plane section 224 and the top surface of the polygon mirror 26 is in different levels, it is also acceptable that the interior angle θ1 of the pressurizing section 27Ad is changed for the purpose of centering the polygon mirror 26 properly.

### Second Embodiment

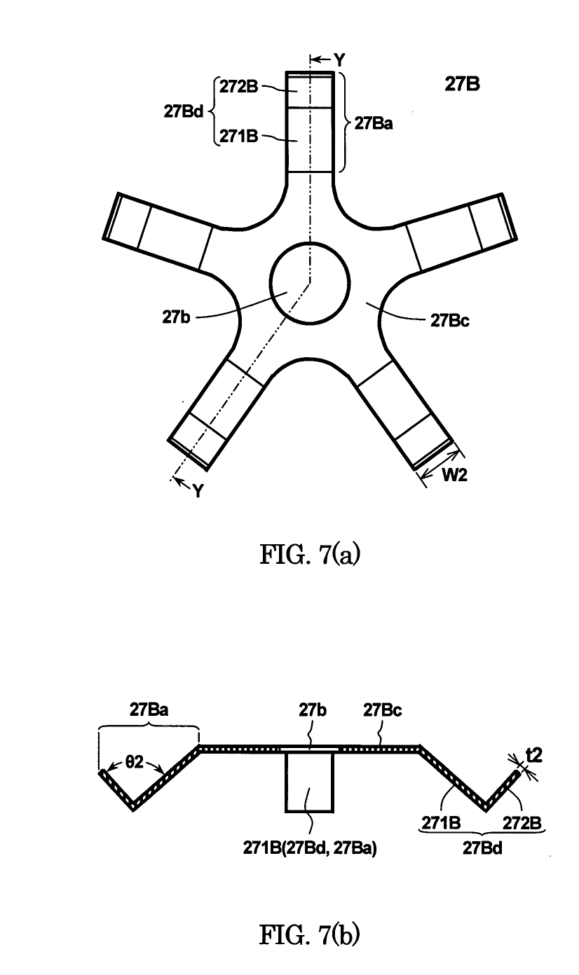

FIG. 7(a) is a plan view of a second elastic plate according to a second embodiment of the present invention.

FIG. 7(b) is a cross sectional view of the second elastic plate taken substantially along line Y-Y of FIG. 7(a).

A motor having improved mechanism (hereinafter generically referred to as a motor) according to a second embodiment of the present invention is identical to the motor according to the first embodiment except for the first elastic plate 27A, so that details of the motor according to the second embodiment other than a second elastic plate 27B are omitted.

In the case of the first embodiment of the present invention, the first elastic plate 27A is provided with four arm sections 27Aa. However, the number of arm sections 27Aa is not limited to be four. For instance, as shown in FIG. 7(a), the second elastic plate 27B enables to be provided with five arm sections 27Ba that extend radially from the center of a flat section 27Bc having a center hole 27b at even intervals of 72 degrees.

Further, each arm section 27Ba is formed with a first slanting section 271B and a second slanting section 272B. The wider a width W2 of the arm section 27Ba is made, the more a spring constant of the second elastic plate 27B increases. In this regard, retaining strength for retaining the polygon mirror 26 enables to be increased more.

Furthermore, as shown in FIG. 7(b), each tip portion of the arm sections 27Ba is folded in reverse to the slanting direction of the arm section 27Ba and formed in a pressurizing section 27Bd in a V-letter shape as the same manner as the first elastic plate 27A shown in FIG. 4.

More, it should be understood that retaining strength of the polygon mirror 26 could be increased by increasing number of arm sections or a thickness t2 of the second elastic plate 27B while leaving the width W2 of the arm section 27Ba constant.

In addition thereto, by changing an interior angle θ2 of the pressurizing section 27Bd, balancing component force in the radial direction and in the thrust direction acting on the polygon mirror 26 enables to be adjusted.

### Third Embodiment

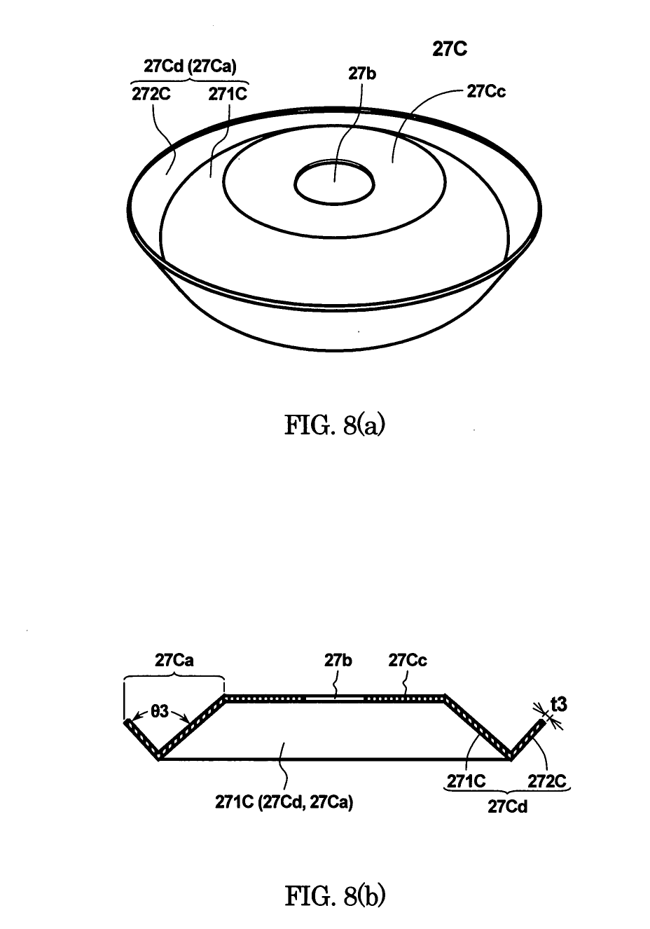

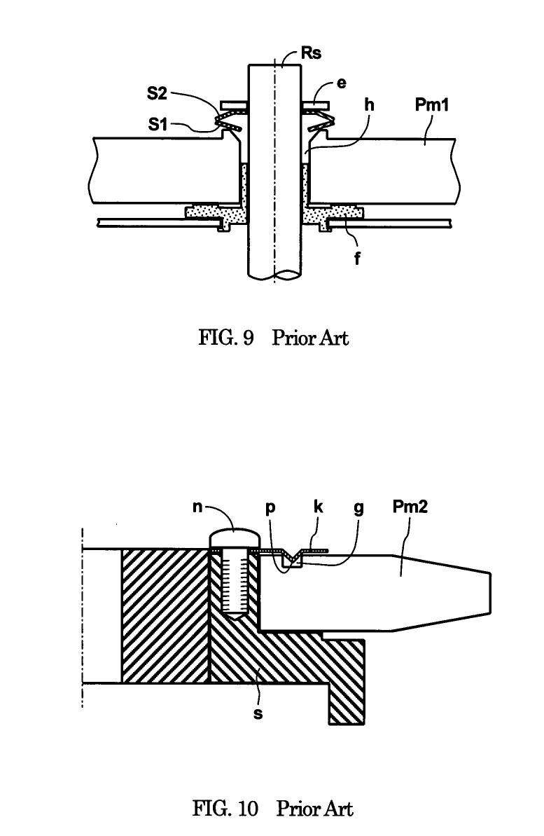

FIG. 8(a) is a perspective view of a third elastic plate according to a third embodiment of the present invention.

FIG. 8(b) is a cross sectional view of the third elastic plate shown in FIG. 8(a).

A motor having improved mechanism (hereinafter generically referred to as a motor) according to a third embodiment of the present invention is identical to the motor according to the first embodiment except for the first elastic plate 27A, so that details of the motor according to the third embodiment other than a third elastic plate 27C are omitted.

In the case of the first embodiment of the present invention, the first elastic plate 27A is provided with four arm sections 27Aa. However, the number of arm sections 27Aa is not limited to be four. In the case of the third embodiment, as shown in FIG. 8(a), the third elastic plate 27C is formed in a cup shape in which first and second slanting sections are continuously disposed in the circumferential direction without any cut. In other words, the third elastic plate 27C is provided with infinite number of arm sections 27Ca. As shown in FIG. 8(b), the third elastic plate 27C is provided with a first slanting section 271C and a second slanting section 272C.

Further, as shown in FIG. 8(b), a pressurizing section 27Cd is formed in a V-letter shape as the same manner as the first elastic plate 27A.

Furthermore, by changing an interior angle θ3 of the pressurizing section 27Cd or changing a thickness t3 of the third elastic plate 27C, balancing component force in the radial direction and in the thrust direction acting on the polygon mirror 26 enables to be adjusted.

Accordingly, the third elastic plate 27C also functions as the same manner as the first elastic plate 27A.

According to an aspect of the present invention, a recessed section is provided between an inner wall surface of a mounting hole, which is formed by boring the center of a body of revolution such as a polygon mirror, and a boss section of a rotor hub. On the other hand, a pressurizing section, which is hit into the recessed section, is formed on an outer circumferential section of an elastic plate. The elastic plate is provided with a first slanting section, which contacts with an outer circumferential edge of the boss section in an inner circumferential side of the recessed section, and a second slanting section, which contacts with a top end circumferential edge of the mounting hole of the polygon mirror in an outer circumferential side of the recessed section. In this regard, the body of revolution enables to be properly retained in a place concentric with a rotor shaft while the elastic plate is centered with respect to the rotor hub, which is concentric with the rotor shaft.

Accordingly, the body of revolution enables to be rotated with balancing the revolution well and to rotate without unbalancing the revolution even in higher rotational speed, and resulting in enabling to maintain rotational balance in higher accuracy.

Further, the elastic plate having the first and second slanting sections enables to be formed integrally in higher accuracy through just one process of press work by using single mold. Therefore, a relative position between and an interior angle of the first slanting section and the second slanting section never varies by production batch.

Accordingly, when manufacturing a motor having improved mechanism, all the elastic plates produced enable to be disposed in a place concentric with the rotor shaft without any error by production batch.

In addition thereto, the elastic plate is formed in a specific mode such that the second slanting section secondly contacts with the top end circumferential edge of the mounting hole of the body of revolution by means of elastic deformation of the first slanting section that firstly contacts with the outer circumferential edge of the boss section. Therefore, the elastic plate is centered first, and then the second slanting section presses uniformly a body of revolution in the radial direction.

Accordingly, the body of revolution enables to be securely retained in a place concentric with the rotor shaft.

While the invention has been described above with reference to a specific embodiment thereof, it is apparent that many changes, modifications and variations in configuration, materials and the arrangement of equipment and devices can be made without departing form the invention concept disclosed herein.

For instance, the first to third embodiments of the present invention are described in the motor having improved mechanism used for rotating a polygon mirror. However, the present invention is also applied for another motor installed with no polygon mirror such as an HDD (hard disc drive) motor for driving a hard disc.

In addition thereto, it will be apparent to those skilled in the art that various modifications and variations could be made in the motor and the disc drive apparatus field in the present invention without departing from the scope of the invention.

What is claimed is:

1. A motor having improved mechanism comprising:
a body of revolution having a mounting hole in the center of the body;
a rotor hub having a boss section to be inserted into the mounting hole of the body of revolution and a flange section supporting the body of revolution; and
an elastic plate installed coaxially to the rotor hub and pressing the body of revolution on the flange section of the rotor hub,
wherein the elastic plate is provided with a plain section having a hole in the center and a plurality of arm sections extending radially from an outer circumference of the plain section, and
wherein each of the arm sections is provided with a first slanting section that is inclined with respect to the plain section and a second slanting section having an angle of gradient different from that of the first slanting section, and
further wherein the first slanting section contacts with an outer circumferential edge of the boss section that confronts with an inner wall surface of the mounting hole of the body of revolution and the second slanting section contacts with a top end edge of the inner wall surface of the mounting hole.

2. The motor having improved mechanism as claimed in claim 1,
wherein the first slanting section is a part of the arm section, which extends from a first portion of the arm section in the plain section side to a second portion outside the first portion, and is inclined toward the boss section totally, and
wherein the second slanting section is another part of the arm section, which extends from the second portion to a tip of the arm section, and is inclined in a direction leaving from the boss section.
